(19) United States
(12) Patent Application Publication
(10) Pub. No.: US 2013/0218993 A1
(43) Pub. Date: Aug. 22, 2013

(54) CONTEXTUAL PRESENCE IN COLLABORATIVE SYSTEMS

(71) Applicants: Krishna Kishore DHARA, Dayton, NJ (US); Venkatesh Krishnaswamy, Holmdel, NJ (US); Xiaotao Wu, Edison, NJ (US)

(72) Inventors: Krishna Kishore DHARA, Dayton, NJ (US); Venkatesh Krishnaswamy, Holmdel, NJ (US); Xiaotao Wu, Edison, NJ (US)

(73) Assignee: Avaya Inc., Basking Ridge, NJ (US)

(21) Appl. No.: 13/571,054

(22) Filed: Aug. 9, 2012

Related U.S. Application Data
(60) Provisional application No. 61/600,884, filed on Feb. 20, 2012.

(51) Int. Cl. G06F 15/16

(52) U.S. Cl. 709/206

(57) ABSTRACT

Disclosed herein are systems, methods, and non-transitory computer-readable storage media for ‘broadcasting’ presence notifications either directly or through complex user-driven systems by replacing the rule-driven approach or the subscription approach with an presence arrangement that is based on context, otherwise known as contextual presence. When a user publishes his or her presence information, either one state or as a set of states, a contextual presence system notifies only those users whose interactions are either expected or do not cause interruptions to users' work. Other than publishing their current presence state or states, contextual presence does not require any configuring or managing from the user and is dynamic both in terms of the changing set of people it notifies and in relation with time.

### PRIORITY CLAIM

The present application claims priority to U.S. Provisional Application No. 61/600,884 filed Feb. 20, 2012, the contents of which are incorporated herein by reference.

### BACKGROUND

1. Technical Field

The present disclosure relates to presence and more specifically to making presence information available to others, such as in a unified communications system, dynamically based on context.

2. Introduction

Currently presence is used widely across unified communications, especially in instant messaging, voice communications, event notifications and in routing. In one typical scenario, a user publishes presence status, such as changing a status from ‘Online’ to ‘In a Meeting’ via an instant messaging application. A friend, contact, or subscriber to the user's presence status receives a notification of the user's presence status or of the change of the user's presence status. The friend's device can provide an active indication based on the notification or can simply change the user's status indicator. The friend can then use that information to either establish an instant message, place a voice call, or as a part of some other communication service that can make a routing, alerting, and other communication choices with respect to that user.

Current systems use one of two approaches for handling presence information. The first approach is a simple presence subscription mechanism and the second approach is rule-based/event-based filtering.

In the simple presence subscription mechanism, a user publishes presence and the presence server notifies the state of the user's presence to all the subscribers. A typical user may have tens or even hundreds of contacts. In this scheme, the subscription mechanism notifies all the contacts. This approach increases the chance that other people will interrupt the user in order to initiate communication based on the presence notification. From the user's point of view, a subset of people who subscribed to the user's presence may not be important at that particular time, but publishing presence information increases the likelihood of interruptions from such people. Such interactions can lower the productivity of enterprise workers.

In a rule-based or event-based filtering system, users have the ability to notify or inform only a subset of users about the presence. However, the user must manually select a subset of users or a group of users, or establish rules for selecting such a group based on time and state of the presence. For example, if the user is available to work on a project proposal and can allow interruptions as long as it is from his co-workers involved in that project, then the user can establish a rule to notify presence to that subgroup. Rule-based systems can be deployed as part of the presence server to filter notifications based on groups.

Thus, users who want to collaborate by allowing co-workers see their presence encounter several problems. First, publishing presence to all their contacts can interrupt the current task at hand. Second, if there is a server mechanism to notify presence to a subgroup of users, then users have to explicitly manage groups by maintaining or managing groups and by adding filtering rules to try capture many different usage scenarios. With enterprise users working on multiple projects during the course of a day this management could get quite involved and can eventually lead to little or no utility value for these systems.

Third, even if subgroups are manually provisioned, the user may not want to publish presence to certain people within a subgroup because their contribution isn't related or is no longer needed for the project. Static groups are not helpful to reduce the problem of limiting notification to only relevant people. Fourth, certain exceptions are difficult to capture in a rule-based engine to filter presence notifications. For example if the user is interacting with someone on a particular day, say a person resolving a problem for the user, to add them in a group and allow them to see presence only during that time can get quite complex.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The principles set forth herein solve the problems of ‘broadcasting’ presence notifications either directly or through complex user-driven systems by replacing the rule-driven approach or the subscription approach with an presence arrangement that is based on context, otherwise known as contextual presence. When a user publishes his or her presence information, either one state or as a set of states, a contextual presence system notifies only those users whose interactions are either expected or do not cause interruptions to users' work. Other than publishing their current presence state or states, contextual presence does not require any configuring or managing from the user and is dynamic both in terms of the changing set of people it notifies and in relation with time.

Further, the contextual presence system extends the notion of contextual presence to enable a new calendar scheduling service. This service opens up a user's calendar based on their contextual presence and not just based on the user's availability. Currently, an open slot in a calendar can be grabbed anyone who can see it, such as subscribers to the calendar entries. If users use a contextual presence enabled calendar scheduling, then certain slots can be opened to only people that are important based on the context. The system can show some scheduling slots as ‘busy’ to less relevant people, and show those same (or other) slots as ‘open’ to more relevant people. The system can decide the relation to contextual presence, i.e. the ‘busy’/‘open’ of a particular calendar slot, based on the context of the user with the person scheduling an event/meeting.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example network configuration embodiment;

FIG. 3 illustrates an example of communicating multiple presence status configurations based on a single presence state;

FIG. 4 illustrates example data interactions with the contextual presence server; and

FIG. 5 illustrates an exemplary method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

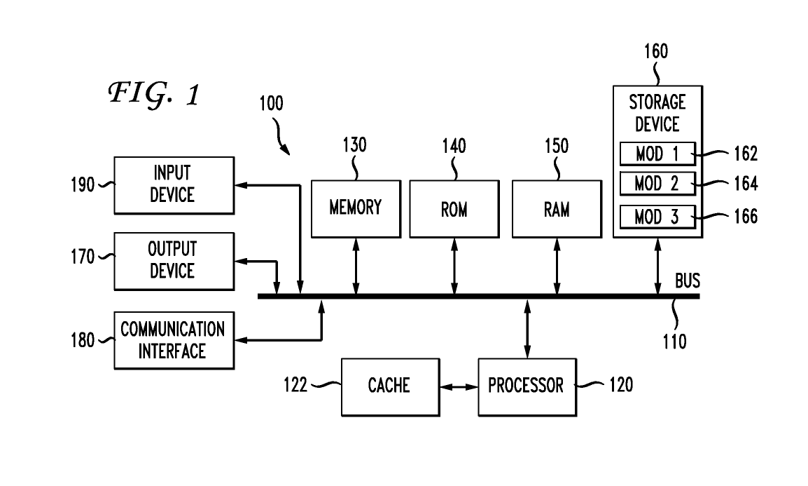

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output system (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod 1 162, Mod 2 164 and Mod 3 166 which are modules configured to control the processor 120. These modules may be stored on the storage device 160 and loaded into RAM 150 or memory 130 at runtime or may be stored as would be known in the art in other computer-readable memory locations.

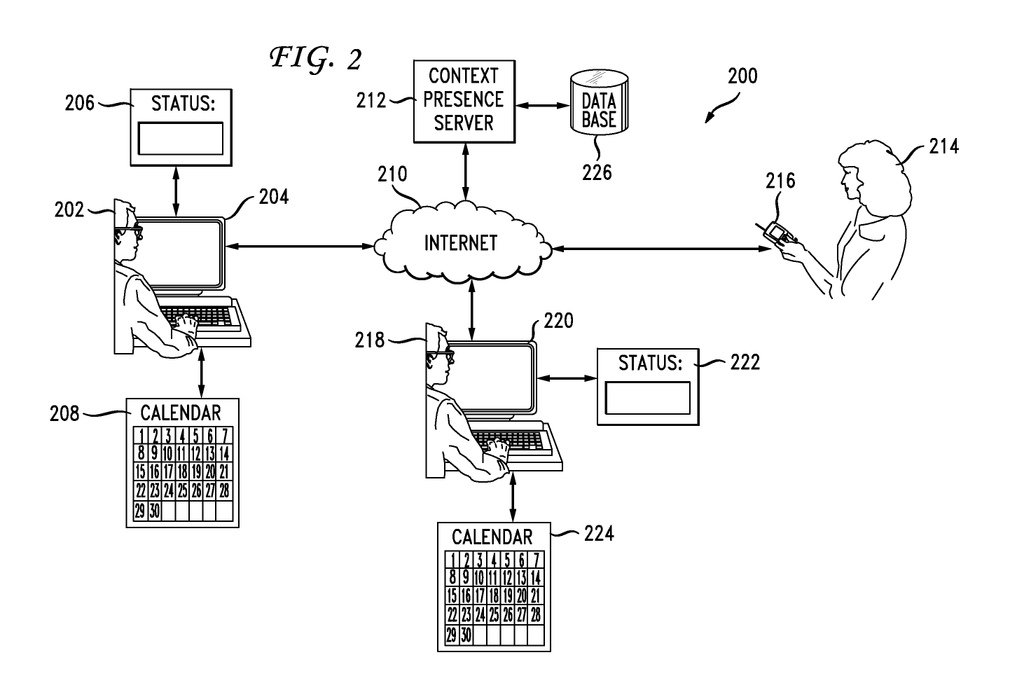

Having disclosed some basic system components and concepts, the disclosure now turns to FIG. 2, which illustrates an example network configuration embodiment 200. In the illustrated embodiment 200, each individual 202, 218, 214 is in contact with one another over the Internet 210 or some other network. In a first configuration, a user 202 enters a presence status 206 into a computing device 204, such as a desktop computer, laptop, tablet computer, or smartphone. The presence status 206 can describe that user's 202 availability (“Busy”, “Available”), current project (“Status Reports”), work load (“Five Projects due Wednesday”), activity level (“Current Pace=2 Reports/Day”), or other information important to the user. While the illustrated configuration the user 202 enters this status 206 into the computing device 204, in other configurations a system or computing device can automatically determine the presence status 206 of the user 202 and enter that status on behalf of the user.

The presence status 206 is communicated through the Internet 210 to a context presence server 212. Upon receiving the presence status 206 the context presence server 212 determines, based on the presence status 206, what presence state other uses 214, 218 should see corresponding to the first user 202. For example, consider if the initial user 202 has a presence status of “busy”, and the two other users are an intern 218 and the initial user's boss 214. The first user is busy and does not want any interruptions from the intern 218, but can (and should) receive interruptions from the boss 214. Therefore the context presence server 212 determines a presence state to send to the remaining users 214, 218, where the presence state received by each user 214, 218 is individualized by the context server 212 to the specific person receiving the status. For example, the boss 214 could see a presence state of “Working,” while the intern 218 sees a presence state of “Busy.” A single presence status from a user 202 can therefore result in the context presence server 212 distributing multiple unique presence states to the other users 214, 218. Alternatively, the context presence server can determine that all other users 214, 218 should receive a single presence state.

In determining which presence state to send to the remaining users 214, 218, the context presence server 212 can access one or more databases 226. This database 226 can provide information to the context server 212, which in turn uses the information to determine the relationships between the various users 202, 214, 216. Additionally, the contextual presence server 212, in preparing a presence state 204 of a first user 202 for a second user 214, can use not only the information from the database 226 and the first user's 202 presence status 204, but also the presence status 222 of a third user 218. For example, if a first user 202 has a presence status 206 of “Out Sick”, and a second user 218 has a presence status 222 of “Covering for a Sick Colleague”, the context presence server 212 can issue to a third user 214 a presence status of “Not Available” with reference to the absent first user 202, and a presence status of “Covering” with reference to the second user 218.

A presence status 206, 222 can be entered by a user 202, 218, 214 using a computing device 202, 220, a smartphone 216, or any other device capable of receiving and recording a status. Similarly, each user 202, 218, 214 can receive presence states of other users from the context presence server 212 on the same devices 204, 220, 216. These computer devices 204, 220, 216 can also contain, or be associated with, individual calendars 208, 224 for their associated users 202, 218. The context presence server 212 can use the calendars 208, 224 in determining the proper presence status to send to each user 202, 218, 214.

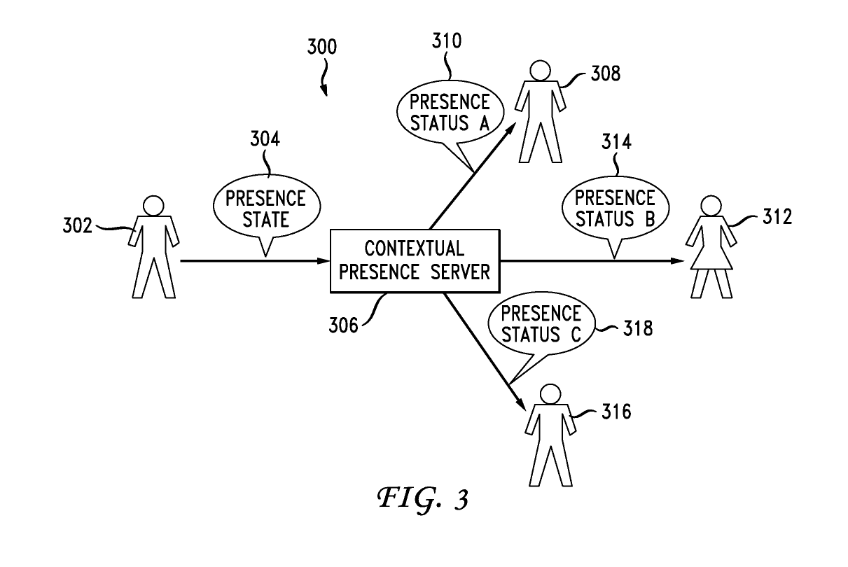

FIG. 3 illustrates an example 300 of communicating multiple presence status configurations based on a single presence state. A first user 302 enters, or has recorded, a presence state 304 which is received by a contextual presence server 306. The contextual presence server 306 determines, based on contexts and relationships between the first user 302 and other users 308, 312, 316, presence status's 310, 314, 318 to send to each of the other users 308, 312, 316. These presence status's 310, 314, 318 can be identical to one another, or each presence status can be unique, based upon the context of the first user's presence status and the relationship between the first user and the person receiving the presence state.

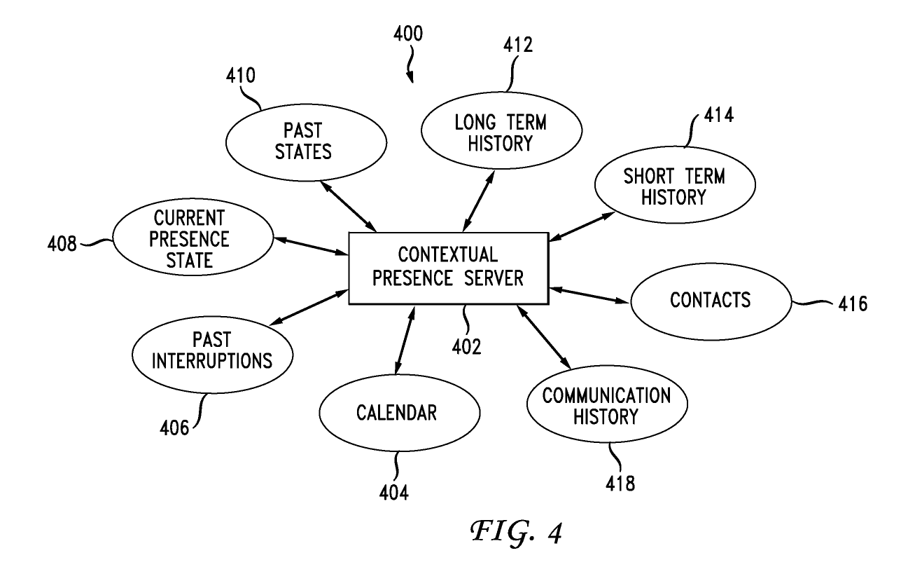

FIG. 4 illustrates example data interactions 400 with a contextual presence server 402. In certain configurations each type of data can be found on a single database, whereas other configurations can have each type of data on a unique database, server, or cloud storage system. Still other configurations could initially receive the data from a separate database and save the information on the contextual presence server 402. While FIG. 4 illustrates multiple data types interacting with the contextual presence server 402, these data types are exemplary only, and are neither exclusive nor inclusive. Each configuration, however, will have access to current presence states 408, as detailed in the descriptions of FIG. 2 and FIG. 3.

The contextual presence server 402 can access past states 410 associated with a specific user or users. From this specific patterns can be determined and stored in a long term history 412, a short term history 414, or immediately used by the context presence server 402. Alternatively, the context presence server 402 can access past states 410, long term history 412, short term history 414, past interruptions 406, and communication history 418 based on a current presence state 408 of one or more of the users. In one example, the context presence server 402 receives presence states 408 from two unique individuals, then considers their communication history 418 and past interruptions 406 between the two individuals. In another example, a user enters a presence status 408, and prior to distributing to others, the contextual presence server 402 first accesses the user's calendar 404 and contacts 416, determines who needs to be in contact with the user, and sends appropriate presence state notifications to the appropriate individuals.

In determining who is appropriate at a given time, or given a particular status, the context presence server 402 can analyze these illustrative factors 404, 406, 408, 410, 412, 414, 416, 418 in any preferred manner. For example, one preferred manner could determine the presence state to communicate using a lattice determination, whereas other preferred manners could determine presence state via a progressive determination using specific factors at each point in the progression. As the contextual presence server 402 makes these determinations, it can update each of the factors 404, 406, 408, 410, 412, 414, 416, 418, or, depending on the configuration, notify other servers or databases containing the information associated with the factors 404, 406, 408, 410, 412, 414, 416, 418 of their use. In this manner, the factors 404, 406, 408, 410, 412, 414, 416, 418 can be updated in a constant, automatic fashion.

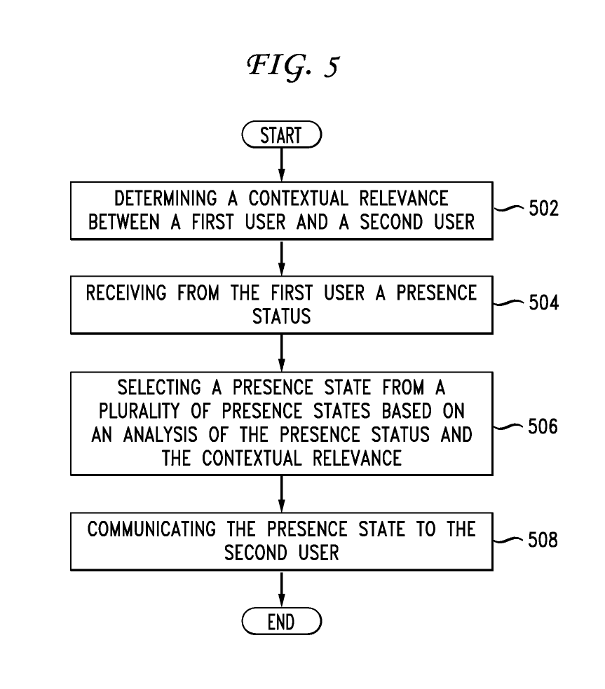

FIG. 5 illustrates an exemplary method embodiment. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps. The exemplary system 100 can represent any computing device, such as a mobile device, computer, Voice over IP phone, softphone, smartphone, presence or calendaring server, telecommunications infrastructure hardware, and so forth, which can be used to implement all or some of the steps set forth herein.

The example contextual presence server uses contextual presence in place of rule-based and/or user-driven filtering approaches to presence notifications. Contextual presence is dynamic and can change based on user ‘normal’ behavior without requiring additional input from the user for filtering notifications. The contextual presence server can constantly monitor and analyze users' communication and collaboration behavior. This disclosure first describes high level steps, and then proceeds to a brief description of the method.

The contextual presence server, which can be a single device or a collection of devices, performs the steps outlined herein. First, users simultaneously publish their presence state or a set of presence states, such as (“Working on project X”, “Available for quick interruptions”, “Available for IM”, “Not available for calls”, etc). The contextual presence server determines users who are able to view the presence states, such as subscribers to users' presence information, based on the presence state and users' contextual relevance. Some exemplary details for determining contextual relevance will be set forth in additional detail below. Based on their relevance score, the contextual presence server allows a first user to see a presence state of “available for quick interrupt” and a second user will either not see any presence status, or will see a different presence state. For example, if the contextual presence server calculates or determines context based on prior history (long or short term), and future predictions state that certain people have low response rates or their calls/emails have fast response rates, the contextual presence server can generate a high score for such a presence state. A high score can trigger notification of the presence state to the relevant users. This approach does not require input from the user, and instead relies on an analysis of the context based on users' prior behavior and predictions or extrapolations therefrom.

Some more detailed examples and illustrative processing approaches for the contextual presence server are set forth below. For a user u, let the presence states at a given moment be {p₁, p₂, . . . , pₙ}. Each pre-defined presence state indicates associated characteristics {c₁, c₂, . . . , cₙ}. Each characteristic cᵢ is a set that identifies certain behavioral characteristics that are related to call activity, email activity, IM activity. When a user publishes a subset of presence states {pᵢ, pⱼ, . . . }, then the contextual presence server computes the following:

For each character set cᵢ that captures the terms of communication primitives for pᵢ, the contextual presence server gets a set of top relevant people based on the historical and predictive models used to compute relevant people in a context engine. The Avaya Context Engine is one example of such a context engine. The context engine computes this as a general example but can use any computation that captures the activity of those communication primitives. Rᵢ is the ranked order of the set of people based on the characteristics specified in cᵢ. The presence server determines the set of people to be notified for each presence state of the user pᵢ based on a threshold. The contextual presence server eliminates people below the threshold from the set Rᵢ.

For example, a user's presence state is “available for quick interruptions”. The contextual presence server detects that this presence state is often characterized by a historical communication behavior that has low response on “email times” or “IM times” or “voice calls”, or “an upcoming meeting”, and more importantly the contextual presence server determines trends in the prior history suggesting that their interaction lasts only for a short time because the user wanted only quick interrupts. When the user changes the state of presence to “available for quick interruptions” the contextual presence server determines or retrieves a list of potential recipients of the presence state change, and culls the list of potential recipients based on a threshold score to determine which users will have access to the presence state change and how a notification, if any, should be delivered. The contextual presence server can also determine how users are able to interrupt. Based on their behavioral patterns, the interruptions fall within the user's intention of quick interruption.

The contextual presence server can optionally overlay this context-aware approach on top of lists, rules, or other manual interactions, as well. For example, a user can establish a set of rules governing how presence state information is shared and with whom. The contextual presence server can further restrict which other users have access to the presence state based on a first threshold, and/or expand which users have access to the presence state based on a second threshold. Certain relationships or users may override the ability of the contextual presence server to restrict availability or sharing of presence states. For example, a manager or supervisor may have unfettered and/or unfiltered access to presence states for employees on his or her team.

The contextual presence approach set forth herein differs from the simple presence or rule-based filtering approach because contextual presence requires little or no input or management of filtering rules from the user, does not broadcast notifications to a static list or group of users, is dynamic, relies on users' historical interaction with the watchers, subscribers, or other users, and is sensitive to the presence states and modality of collaboration. Contextual presence allows users to automatically publish their presence state to only those contacts that are relevant to the historical communication and collaboration patterns the user intends to in that published presence state. The contextual presence server can use the approaches set forth herein to filter events, for example. The contextual presence server can predict or forecast other users' interest in a particular presence state, and prevent notification broadcasts to users who are not likely to be interested in the presence state, or with whom the user associated with the presence state is unlikely to want to share.

The exemplary method shown in FIG. 5 begins when a system 100 first determines a contextual relevance between a first user and a second user (502). The system then receives from the first user a presence status (504), such as “Busy” or “Available.” These steps, (502) and (504) can occur in any order or simultaneously. For example, if a professor and a student were using the system, a contextual relevance between the professor and the student could be determined before the professor posts a status of “Office Hours.” Alternatively, the contextual relevance between the professor and the student could be determined after the professor updates the contextual status, or determined when the professor is entering a contextual status.

Upon determining the contextual relevance between the a first user and a second user (502) and receiving from the first user a presence status (504), the system 100 selects a presence state from a plurality of presence states based on an analysis of the presence status and the contextual relevance. This analysis can take into account the relationship of the first user and the second user, previous history, interruptions, importance of current tasks, calendaring conflicts, and other factors relevant to the relationship. Continuing with the example of the professor and the student, the system 100 could determine, based on a status of “Office Hours,” that a presence state of “Available” is appropriate. The system 100, if the relationship were between the professor and a non-student, could similarly determine that a presence state of “Busy” is more appropriate for a professor-non-student relationship. Having selected a presence state, the system 100 then communicates the presence state to the second user (508). This presence state communication depends on how the system 100 is configured, and can be a visual communication, an email, an audible notification, or any other compatible form of communication. One common form of communicating the presence state to the second user is updating an Instant Messenger status on an Instant Messenger application belonging to the second user with the presence state selected.

Applying this method to a calendaring program can allow scheduling based on a user's contextual presence and not just based on the user's availability. For example, whereas traditional shared calendaring allows an open slot in a calendar to be filled by anyone who can see it, a calendaring system employing the disclosed method can first receive a presence status from a user, then determine the presence state(s) to be sent to other users. Certain calendaring slots can be opened to only people that are important based on the user status and the presence state(s) sent. For example, the system 100 can show some scheduling slots as ‘busy’ to less relevant people, and show those same (or other) slots as ‘open’ to more relevant people. The system 100 can decide the relation to contextual presence, i.e. the ‘busy’/‘open’ of a particular calendar slot, based on the context of the user with the person scheduling an event/meeting.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied to adapt user interfaces for local applications, web-based applications, and/or mobile devices. Those skilled in the art will readily recognize various modifications and changes that may be made to the principles described herein without following the example embodiments and applications illustrated and described herein, and without departing from the spirit and scope of the disclosure.

We claim:

1. A method comprising:
determining a contextual relevance between a first user and a second user;
receiving from the first user a presence status;
selecting, via a processor, a presence state from a plurality of presence states based on an analysis of the presence status and the contextual relevance; and
communicating the presence state to the second user.

2. The method of claim 1, wherein the analysis considers calendars associated with the first user and the second user.

3. The method of claim 1, further comprising:
selecting a second presence state from the plurality of presence states based on the analysis, where the second presence state is different than the presence state.

4. The method of claim 3, further comprising:
communicating the second presence state to the first user.

5. The method of claim 1, wherein the first user and the second user have a relationship where one of the first user and the second user has a superior job title to the other.

6. The method of claim 1, wherein determining the contextual relevance between the first user and the second user is based at least in part on a number of past interruptions.

7. The method of claim 1, wherein the contextual relevance comprises a relevance score based on a previous communication history.

8. A system comprising:
a processor; and
a non-transitory computer-readable storage medium storing instructions which, when executed on the processor, perform a method comprising:
determining a contextual relevance between a first user and a second user;
receiving from the first user a presence status;
selecting a presence state from a plurality of presence states based on an analysis of the presence status and the contextual relevance; and
communicating the presence state to the second user.

9. The system of claim 8, wherein the analysis considers calendars associated with the first user and the second user.

10. The system of claim 8, the non-transitory computer-readable storage medium storing additional instructions which, when executed on the processor, perform a method comprising:
selecting a second presence state from the plurality of presence states based on the analysis, where the second presence state is different than the presence state.

11. The system of claim 10, the non-transitory computer-readable storage medium storing additional instructions which, when executed on the processor, perform a method comprising:
communicating the second presence state to the first user.

12. The system of claim 8, wherein the first user and the second user have a relationship where one of the first user and the second user has a superior job title to the other.

13. The system of claim 8, wherein determining the contextual relevance between the first user and the second user is based at least in part on a number of past interruptions.

14. The system of claim 8, wherein the contextual relevance comprises a relevance score based on a previous communication history.

15. A non-transitory computer-readable storage medium storing instructions which, when executed by a computing device, cause the computing device to perform a method comprising:
determining a contextual relevance between a first user and a second user;
receiving from the first user a presence status;
selecting a presence state from a plurality of presence states based on an analysis of the presence status and the contextual relevance; and
communicating the presence state to the second user.

16. The non-transitory computer-readable storage medium of claim 15, wherein the analysis considers calendars associated with the first user and the second user.

17. The non-transitory computer-readable storage medium of claim 15, the non-transitory computer-readable storage medium storing additional instructions which, when executed on the computing device, perform a method comprising:
selecting a second presence state from the plurality of presence states based on the analysis, where the second presence state is different than the presence state.

18. The non-transitory computer-readable storage medium of claim 17, the non-transitory computer-readable storage medium storing additional instructions which, when executed on the computing device, perform a method comprising:
communicating the second presence state to the first user.

19. The non-transitory computer-readable storage medium of claim 15, wherein the first user and the second user have a relationship where one of the first user and the second user has a superior job title to the other.

20. The non-transitory computer-readable storage medium of claim 15, wherein determining the contextual relevance between the first user and the second user is based at least in part on a number of past interruptions.
